(19) United States
(12) Patent Application Publication
(10) Pub. No.: US 2015/0039265 A1
(43) Pub. Date: Feb. 5, 2015

(54) Method And Apparatus For Characterising Samples By Measuring Light Scattering and Fluorescence

(71) Applicant: Spectrayls Innovation, Romainville (FR)

(72) Inventors: Abdelhaq Acharid, Arnouville (FR); Inès Birlouez-Aragon, Ermont (FR)

(21) Appl. No.: 14/386,902

(22) PCT Filed: Mar. 20, 2013
(86) PCT No.: PCT/IB2013/052207

§ 371 Date: Sep. 22, 2014

(30) Foreign Application Priority Data
Mar. 22, 2012 (FR) 12 52569

(51) Int. Cl. G01N 21/47; G01N 21/64

(52) U.S. Cl. CPC G01N 21/47; G01N 21/64; G01N 2201/062
USPC 702/179

(57) ABSTRACT

A method for characterising at least one sample, the method including the steps of a) the lighting of each sample to be analysed by N>1 light rays (LE1-LE3) at respective wavelengths of light (λε1-λE3); b) the acquisition, for each of the light rays, of at least one fluorescent light intensity and at least one elastic scattering light intensity emitted by each sample; c) determining a vector indicator for each sample based on said fluorescent and elastic scattering light intensities; d) determining at least one parameter characterising each sample, or a method to which the sample was submitted, based on the corresponding vector indicator. Apparatus for implementing such a method is also provided.

The invention relates to a method and an apparatus for characterizing samples, and notably foods, medicines, and biological or environmental media, exploiting light scattering and fluorescence measurements and a statistical processing of said measurements.

The invention can be applied in particular, but not exclusively, to the agro-food or pharmaceutical industry. For example, it makes it possible to study the trend of the nutritional and/or toxicological properties of a food during its preparation or conservation, and to control the processes to which a food is subjected (cooking, roasting, etc.).

The invention can also be applied to the environmental industry, for example to the treatment of wastewaters, industrial muds, fermentation media, etc.

More generally, the invention can be applied to the determination of any indicator of quality of a sample, and/or of any parameter characterizing a method to which said sample has been subjected.

The method is based on chemometric methods, and in particular, in advantageous embodiments of the invention, on the multivariable or—preferably, multiway statistical analysis of spectroscopic data. Multiway analysis is the natural extension of multivariable analysis when the data are arranged in tables with three or more ways. It is based on the use of statistical models such as “PARAFAC” (“Parallel Factor”, i.e. parallel factor model) and NPLS (“N-ways Partial Least Squares regression”). Reference in this respect can be made to the reference work by R. Bro, “Multi-way Analysis in the Food Industry Models, Algorithms, and Applications”, PhD thesis, Amsterdam University, 1998.

The document WO 2011/080408 describes a method and an apparatus for the spectroscopic analysis of samples, in particular food samples, implementing a multiway processing of spectroscopic data. The method comprises the lighting of each sample to be analyzed by a plurality of excitation light radiations at respective wavelengths; the acquisition of a plurality of frontal fluorescence spectra from each sample, each corresponding to a respective excitation light radiation; a preprocessing of these fluorescence spectra, intended in particular to subtract from them a contribution due to Rayleigh scattering; the application to the preprocessed spectra of a multiway statistical model and the determination—for example by multilinear regression—of an indicator of quality of each sample and/or of a parameter characterizing a method to which each sample has been subjected.

The document WO 2011/158192 describes a method for characterizing one or more samples of an agro-food product which also uses the acquisition of a plurality of frontal fluorescence spectra from each sample and their processing by means of a multiway data analysis method. This method culminates in the representation of each sample by a point in a multidimensional space, which makes it possible to compute a distance relative to one or more reference samples. This distance makes it possible, for example, to quantify the naturality and/or the freshness of the sample. The articles:
“Analysis of visible reflectance spectra of stored, cooked and diseased chicken meats”, Y. Lio and Y.-R. Chen, Meat Science 58 (2001), pages 395-401; and
“The Use of Visible and Near-Infrared Reflectance Measurements to assess Sensory Changes in Carrot Texture and Sweetness during Heat Treatment”, N. De Belie et al., Biosystems Engineering (2003) 85(2) pages 213-225

describe methods for characterizing food samples, that make it possible in particular to study their cooking, based on the application of multiway analysis methods to reflectance spectra.

The implementation of these methods is relatively complex, and therefore costly, because it entails acquiring and processing a plurality of spectra, and therefore a significant volume of data.

The invention aims to overcome these drawbacks in the prior art.

One subject of the invention that makes it possible to achieve this aim is a method for characterizing at least one sample, comprising:

a) the lighting of said or each sample to be analyzed by N≧1 light radiations at respective lighting wavelengths;

b) the acquisition, for each said light radiation, of at least one fluorescence light intensity and of at least one elastic scattering light intensity emitted by said or by each sample;

c) for said or each sample, the determination of a vector indicator from said fluorescence and elastic scattering light intensities;

d) the determination of at least one parameter characterizing each sample, or a method to which said sample has been subjected, from the corresponding vector indicator.

By contrast to the abovementioned methods known from the prior art, and more particularly from the documents WO 2011/080408 and WO 2011/158192, a method according to the invention is characterized by the combined use of fluorescence and scattering data which makes it possible to improve the characterization of the sample and/or to reduce the number of lighting sources used, and therefore to simplify the instrumentation implemented. It should be stressed that, in the abovementioned documents WO 2011/080408 and WO 2011/158192, the intensity of the scattered light is seen only as a nuisance disturbing the acquisition of the fluorescence spectra, which are considered to be the sole bearers of usable information.

According to different particular embodiments of the method of the invention:
Said fluorescence and elastic scattering light intensities can be acquired in frontal mode.
Said step a) can comprise the lighting of said or each sample to be analyzed by a number between 1 and 6 of substantially monochromatic light radiations.
Said step b) can comprise, for said or each sample, the acquisition of at least one fluorescence spectrum and said step c) can comprise, also for said or each sample
   the computation of a scores vector by the application of a multivariable or multiway statistical model to said or to each fluorescence spectrum, said statistical model being defined by a lighting loadings vector and by a fluorescence loadings vector; and
   the concatenation of said scores vector with at least one elastic scattering intensity value or a parameter characteristic of at least one elastic scattering spectrum.
Said statistical model implemented in the step c) can be chosen from a PARAFAC model and an NPLS model.
Said step b) can comprise, for said or each sample, the acquisition of at least one spectrum comprising contributions due to the fluorescence and to the elastic scattering, and the subtraction of said contributions due to the elastic scattering of the excitation light radiation, said contributions due to the elastic scattering being able in particular to be computed, notably by means of a generalized linear model. In other words, a generalized linear model can be used to separate the contributions due to the fluorescence and to the elastic scattering, these two contributions then being able to be used for the characterization of the sample.
The method can also comprise a preliminary calibration phase comprising:
i) the lighting of a plurality of calibration samples by said N≧1 light radiations at said respective lighting wavelengths;
ii) the acquisition, for each said calibration sample, of said fluorescence spectrum or spectra;
iii) the determination, by an iterative method, of said loadings vectors of the statistical model, and of a scores vector for each calibration sample.
Said step d) of determination of at least one parameter characterizing each sample, or a method to which said sample has been subjected, can be implemented by a method chosen from: a multilinear regression from said vector indicator; the computation of a distance between said vector indicator and a reference vector; a supervised or unsupervised classification method; and a “scoring” method.
The method can also comprise a preliminary calibration phase comprising the determination of a function linking said vector indicator to the known values of said or each parameter for said calibration samples.
Said or each sample can be a product chosen from a food, a medicine, a biological medium or an environmental medium.
Said or each said scalar or vector parameter can be representative of a physical chemical structure of a matrix of said sample, or of a transformation of said physical-chemical structure.

Another subject of the invention is an apparatus for characterizing at least one sample comprising:
at least one light source for lighting said or each sample to be analyzed by N≧1 light radiations at respective lighting wavelengths;
an acquisition means for acquiring at least one fluorescence light intensity and at least one elastic scattering light intensity emitted by said or by each sample for each said light radiation; and
a means for processing data representing the acquired light intensities, programmed or configured to implement a method as described above. The data processing means can typically be a computer or a processor suitably programmed.

Other features, details and advantages of the invention will become apparent on reading the description given with reference to the attached drawings which are given by way of example, in which:

FIG. 1 represents the block diagram of a device for implementing a method according to the invention;

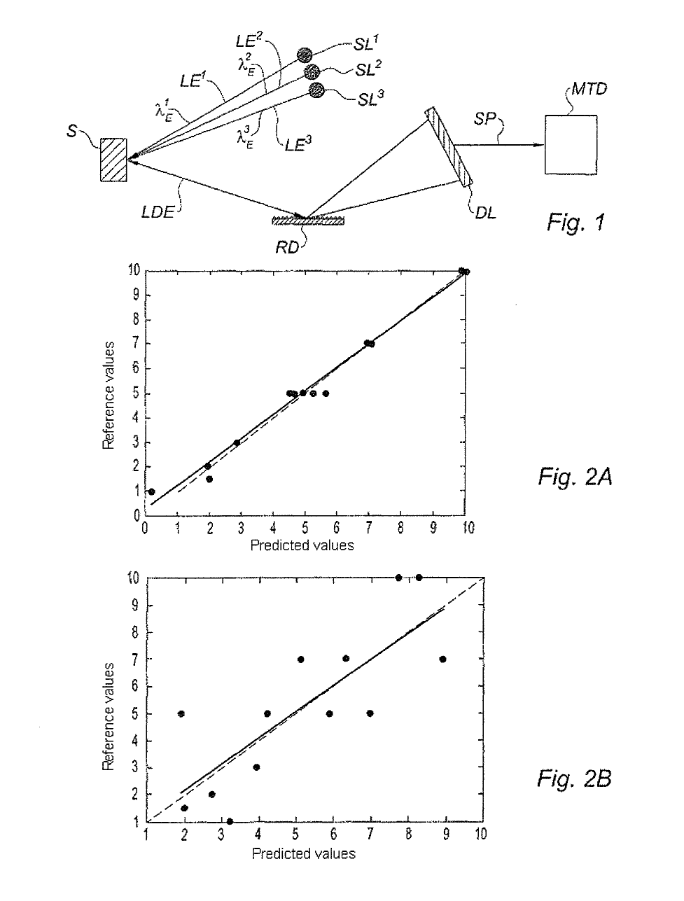

FIGS. 2A and 2B show how the combined inclusion of the fluorescence and the elastic scattering of the light enhances the prediction of the beef cooking time compared to the use of the fluorescence alone;

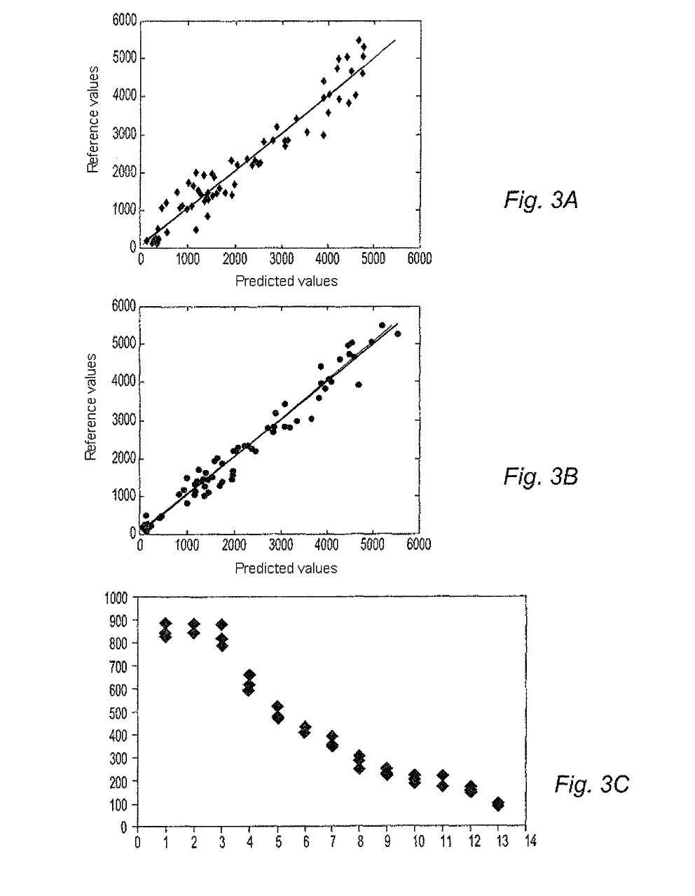

FIGS. 3A and 3B show how the combined inclusion of the fluorescence and the elastic scattering of the light enhances the prediction of the trend of the acrylamide content during the roasting of chicory compared to the use of fluorescence alone; and

FIG. 3C shows the trend of the scattering intensity at 430 nm of the chicory during roasting.

The apparatus of FIG. 1 comprises three monochromatic light sources SL¹, SL² and SL³, generating respective lighting light radiations at wavelengths λ_{E}¹, λ_{E}², λ_{E}³. Alternative embodiments of such an apparatus could comprise a greater or lesser number of monochromatic light sources (at the limit, just one), even a polychromatic light source generating all the lighting radiations.

The radiations LE¹-LE³ are directed—simultaneously or in turn—toward the sample S, which can be a solid, a powder, a liquid contained in a transparent container, etc. Following its lighting by each incident radiation LEⁱ, the sample S emits an LDF radiation which essentially comprises two contributions: one, at the same wavelength as the lighting radiation, due to the elastic scattering; the other, polychromatic, due to the fluorescence. A diffraction grating RD breaks down the LDF radiation into its spectral components. The resultant light spectrum, SP, is acquired by a matrix sensor is DL, generating signals which, after conversion into digital format, are processed by the data processing means MTD.

In the embodiment of FIG. 1, the scattering and the fluorescence are detected in frontal mode, that is to say on the same side of the sample S which receives the incident light. This is not essential.

Similarly, a dispersive element other than a diffraction grating—for example a prism—can be used to break down the LDF radiation into its spectral components; it is even possible to replace the dispersive element with a Fourier transformed spectrometer. According to another variant, it is possible to use a spot light detector, mobile or associated with a rotating grating or prism (apparatus of monochromator type).

The use of a diffraction grating offers an advantage, that of giving access to a number of orders of diffraction. The benefit is being able to access the scattering amplitude, even if the detector used is saturated by an excessively strong light intensity (typically scattering light intensity). The replica due to the second order of diffraction is in fact much weaker than that of the first order, and therefore makes it possible to access the amplitude of the first order spike (the ratio between the intensity diffracted in each order being constant, and depending only on the grating). It is thus possible to obtain, at the same time, a high fluorescence signal and the scattering amplitude.

Particularly when the “monochromatic” lighting sources exhibit relatively wide spectra (for example, they are light-emitting diodes), the spectrum acquired by the sensor DL comprises contributions due to the elastic scattering and to the fluorescence which partially overlap. In this case, a preprocessing can be provided in order to eliminate this contribution; the abovementioned document WO 2011/080408 describes a preprocessing method of this type, based on the prediction of the scattering region which overlaps the fluorescence via a generalized linear model (GLZ) with a log link function. This same document also describes other preprocessing operations (normalization, multiplicative correction of the dispersion, etc.) which can also be applied to the present invention.

As in the method of the abovementioned document WO 2011/080408, the application of a statistical model to the fluorescence light intensity values acquired by the sensors DLⁱ provides a vector, called “scores” vector, which characterizes the sample. In accordance with one embodiment of the invention, a vector indicator, or explanatory vector, is constructed by concatenation of said scores vector and of one or more elastic scattering intensity values. In its turn, this vector indicator makes it possible to obtain a parameter—scalar or vector—characterizing the sample S or a method to which the latter has been subjected. Preferably, said or each scalar or vector parameter will be representative of a physical-chemical structure of a “matrix”—in solid, liquid or powder form—of said sample or of a transformation of such a structure. It may be, for example, the content in terms of a compound, or in terms of several compounds of one and the same family, or even a parameter quantifying the physical chemical modifications of said matrix induced by a method such as cooking. “Matrix” should be understood to be the main component of the sample, forming a relatively uniform mass, exhibiting a substantial continuity and potentially containing other minority components such as dispersed particles or droplets in suspension.

In certain cases, the fluorescence “scores” vector can be replaced, or complemented, by a vector made up of a certain number (generally between 1 and 6) of fluorescence intensity values at discrete wavelengths.

In certain cases, the vector indicator can also contain information on the form of one or more elastic scattering spectra. In effect, these spectra are not necessarily identical to the corresponding lighting spectra. Thus, for example, a vector indicator can be obtained by concatenating a fluorescence scores vector, one or more discrete elastic scattering intensity values and one or more scalar parameters representative of the form or of the width of one or more elastic scattering spectra.

Implementing the method first of all entails a calibration phase, involving a plurality of calibration samples Sⁱ. The duly acquired fluorescence spectra—if necessary, after “cleaning” the stray contributions due to the elastic scattering—are organized as a third order data tensor (“data cube”) whose three “pathways” are: the samples, the lighting radiations, wavelengths of the fluorescence spectra. If the lighting is monochromatic, the data are represented by a second order tensor.

The statistical model applied to the data can be of the “PARAFAC” type, which consists in breaking down a three-way tensor X into a sum of external products of three vectors (“triads”) aᵢ, bᵢ, cᵢ, plus a residue E, also in the form of a “data cube”. The following can then be written:

$${x}_{ijk} = {\sum }_{f = 1}^{F} {a}_{if} {b}_{jf} {c}_{kf} + {e}_{ijk} ,$$

in which: “i”, which runs from 1 to I>1, is the index of the samples; “j” which runs from 1 to J>1, is the index of the lighting wavelengths; “k”, which runs from 1 to K>1 is the index of the wavelengths of the fluorescence spectra corresponding to each lighting radiation; “f” is the index of the F PARAFAC breakdown factors. The number F of factors can be defined a priori, or using criteria known from the prior art.

The vector (with F components) a_{i.}=(aᵢ₁ . . . a_{iF}) is called the “scores” vector for the sample Sⁱ, whereas the vectors bⱼ.=(bⱼ₁ . . . b_{jF}) and cₖ.=(cₖ₁ . . . c_{kF}) are the lighting and emission “loadings” vectors, respectively, which define the statistical model. These vectors are determined, by known iterative methods (for example, alternate least squares), in such a way as to minimize the tensorial Frobenius norm of the residue E, i.e. the value of ∥X−Xₘₐₜ∥_{FRO}, where Xₘₐₜ corresponds to the data cube of the PARAFAC model (see below) and ∥.∥_{FRO} denotes the Frobenius norm (or any other suitable norm).

The PARAFAC model can be rewritten in matrix form as follows:

Xₘₐₜ=A(C|\textcircled{×} |B)^{T}

in which:
Xₘₐₜ is the matrix−of size I×(J*K)−of the intensities of the different radiations emitted by fluorescence by the samples; this matrix contains the same information as the three-way tensor X, but organized differently;
B and C are the matrices (of size J*F and K*F elements, respectively) of the lighting and emission “loadings”, the columns of which are formed by the vectors bⱼ^{T}. and cₖ.^{T};
A_{IF} is the matrix (of size I*F) of the “scores”, the columns of which are formed by the vectors aᵢ^{T}.;
the symbol |\textcircled{×} |represents the tensorial Khatri-Rao product; and
the exponent T indicates the transposition operation.

This model makes it possible to obtain a scores vector for a new sample, after the calibration has been done. In effect, if X_{new} is taken to be the vector with J*K components containing the fluorescence spectra acquired for said new sample; the vector (of dimensions F) of the scores for this new sample is given by

A_{new}=(|\textcircled{×} |C)⁺X_{new};

in which the exponent + indicates the generalized inverse of the tensorial product.

It is, however, important to note that the “PARAFAC” model is empirical; it is therefore valid only for samples similar to those which have been used in calibration.

Then, a vector indicator is constructed from the scores vectors and, for example, one or more elastic scattering intensity values, even also one or more fluorescence intensity values at discrete wavelengths. This will be able to be done simply by concatenation.

Then, a multilinear regression model can be constructed from the calibration data to allow for the prediction, as a function of said vector indicator, of a parameter (even several) characterizing the samples and/or a method to which they have been subjected. This parameter can, for example, be the content of a determined component, or a cooking time. Obviously, the value of the characterizing parameter must be known for the calibration samples.

Several variants of the characterization method described above can be envisaged without departing from the scope of the present invention. For example, the statistical model may not be of PARAFAC type but, for example, N-PLS type, or another known type (on this topic, see the abovementioned work by R. Bro). Furthermore, the transition from the vector indicators (which, it will be recalled, can be made up of the fluorescence scores vectors concatenated with parameters representative of the elastic scattering) to the parameters characterizing the samples can be done in ways other than by multilinear regression, for example by computing a distance—Euclidian or Mahalanobis—between the vector indicator of each sample considered and that of a reference sample. It is also possible to make use of supervised or unsupervised classification techniques, or of a supervised method known as “scoring”.

“Scoring” is a data ranking technique which makes it possible to evaluate, via a score, the probability that a sample or a group of samples resembles another sample or another group of samples. This probability is computed from the vector indicators defined above.

As a nonlimiting example, the following method can be used:

From the PARAFAC fluorescence scores and the scattering intensities, a matrix M(n×m) is constructed in which n is the number of samples, and m is the number of variables, that is to say of components of each vector indicator.

A vector indicator of distance y is then computed by using a linear regression model

y=b₁a₁+b₂a₂ + . . . +bₘaₘ+e

The vector y is binary and takes the values: zero for the so-called reference samples, and one for the samples to be characterized. The vectors aᵢ are the columns of the matrix M, the scalars bᵢ are the coefficients of the linear model; e is the vector of the residues.

A Student test t is applied to the distances ŷ\hat{yᵣ} predicted from the scores and scatterings of the reference sample and from the distances ŷ\hat{yₛ} predicted from the scores and scatterings of the sample to be characterized. The statistic t is computed by the following equation:

$$t = \frac{( \overline{\hat{{y}_{r}}} - \overline{\hat{{y}_{s}}} )}{\sqrt{\frac{{S}_{\hat{{y}_{r}}}}{{n}_{r}} + \frac{{S}_{\hat{{y}_{s}}}}{{n}_{s}}}}$$

in which {circumflex over ( y̅ᵣ̅ , {circumflex over ( y̅ₛ̅ ; S\hat{_{y}_{ᵣ}}; S\hat{_{y}_{ᵣₛ}}; nᵣ and nₛ are respectively the averages of the distances provided by the linear regression model, their variances (S) and the number of replicas (n) used in the gauging for the reference (index r), and for the sample (index s).

The “scoring” score is expressed as a function of the probability density:

$$p ( t ) = \frac{Γ ( \frac{v + 1}{2} )}{\sqrt{v π} Γ ( \frac{v}{2} )} {( 1 - \frac{{t}^{2}}{v} )}^{- 0.5 ( v + 1 )} ;$$

$$for v \geq 1$$

in which Γ is the Euler gamma function and v the degree of freedom

$$v = \frac{{( \frac{{S}_{\hat{{y}_{r}}}}{{n}_{r}} + \frac{{S}_{\hat{{y}_{s}}}}{{n}_{s}} )}^{2}}{\frac{{( \frac{{S}_{\hat{{y}_{r}}}}{{n}_{r}} )}^{2}}{( {n}_{r} - 1 )} + \frac{{( \frac{{S}_{\hat{{y}_{s}}}}{{n}_{s}} )}^{2}}{( {n}_{s} - 1 )}}$$

The samples that exhibit a higher external probability, on the basis of the null hypothesis over the distributions (H₀: {circumflex over ( y̅ᵣ̅={circumflex over ( y̅ₛ̅), receive the higher scores, that is to say closer to 1.

The technical results of the invention will be illustrated above using two exemplary applications.

The first example relates to controlling the cooking of a food, and in particular of beef.

Measuring the scattering by analyzing the reflectance of the surface of a piece of meat during cooking makes it possible to plot a kinetic curve of the cooking level. The variations of the scattered light intensity over time notably reflect the formation of proteic aggregates deriving from the denaturing of the proteins with heat, a phenomenon which is reflected visually by the change of color of the medium. In the case of other foods, fish or egg white, a loss of transparency of the medium is, rather, noted. In the case of the heating or clotting of milk, no modification is perceptible to the naked eye, but a quantitative measurement shows that, even in this case, the scattering evolves in relation to the formation of aggregates of denatured serous proteins. The fluorescence is also affected by the chemical and physical-chemical transformations which occur during the cooking. It is therefore possible to define an optimal cooking level and its translation in terms of trend kinetic of the scattering or—better—of the scattering-fluorescence combination, measured in the form of distance (Euclidian or Mahalanobis) relative to the initial level. Another approach consists in constructing a regression over the cooking time and identifying the optimal time predicted by the combination of the fluorescence and scattering signals.

Table 1 indicates the correlation coefficients obtained between the different PARAFAC scores computed for samples of beef grill-cooked at 180° C. for 10 min, for the four identified factors (Fact1 to Fact4), as well as the maximum scattering and fluorescence intensities at different wavelengths (the term maximum intensity applies because the scattering and fluorescence spectra exhibit a finite width). More specifically:
D1S1 corresponds to the maximum elastic scattering intensity of a lighting radiation at 280 nm, measured in correlation with the first order of diffraction of the grating RD;
D1S2 corresponds to the maximum elastic scattering intensity of a lighting radiation at 375 nm, measured in correlation with the first order of diffraction of the grating RD;
D2S2 corresponds to the scattering intensity at 375 nm, measured in correlation with the second order of diffraction of the grating RD; and
D1S3 corresponds to the maximum elastic scattering intensity of a lighting radiation at 430 nm, measured in correlation with the first order of diffraction of the grating RD.

The correlation table shows, on the one hand, that the fluorescence is significantly correlated with the scattering and that the fluorescence and light scattering, are correlated with the cooking time.

TABLE I

| | Fact1 | Fact2 | Fact3 | Fact4 | D1S1 | D1S2 | D2S2 | D1S3 | Time |
|---|---|---|---|---|---|---|---|---|---|
| Fact1 | 1 | −0.95 | 0.52 | −0.96 | 0.55 | 0.48 | 0.50 | −0.06 | −0.58 |
| Fact2 | | 1 | −0.48 | 0.88 | −0.48 | −0.43 | −0.45 | 0.05 | 0.60 |
| Fact3 | | | 1 | −0.72 | −0.06 | −0.03 | −0.04 | −0.36 | −0.19 |
| Fact4 | | | | 1 | −0.43 | −0.40 | −0.41 | 0.17 | 0.55 |
| D1S1 | | | | | 1 | 0.77 | 0.77 | 0.61 | −0.55 |
| D1S2 | | | | | | 1 | 1 | 0.71 | −0.44 |
| D2S2 | | | | | m | | 1 | 0.69 | −0.44 |
| D1S3 | | | | | | | | | −0.30 |
| Time | | | | | | | | | 1 |

FIG. 2A illustrates the multilinear regression model of the cooking time (x axis: predicted cooking time, in minutes; y axis: real cooking time) obtained only from the fluorescence data (vectors of the scores of the four PARAFAC factors); FIG. 2B illustrates the regression model obtained by also using the maximum elastic scattering intensity at 280 nm (D1S1). In both cases, the calibration was performed on a basis of 14 samples. It can be seen that the inclusion of the elastic scattering very considerably enhances the prediction of the cooking time; in effect, the mean square prediction error changes from 1.60 minute to 0.35 minute.

The second example relates to the trend of the acrylamide content of the chicory during its roasting.

Table II indicates the correlation coefficients obtained between the different PARAFAC scores for four factors (Fact1 to Fact4), as well as the maximum scattering and fluorescence intensities at different wavelengths. D1S1, D1S2 and D1S3 have been defined by precedence; D2S1 corresponds to the elastic scattering at 280 nm observed with the second order of diffraction of the grating RD.

TABLE II

| | Fact1 | Fact2 | Fact3 | Fact4 | D1S1 | D1S2 | D2S2 | D1S3 | Acrylamide |
|---|---|---|---|---|---|---|---|---|---|
| Fact1 | 1 | 0.46 | −0.91 | −0.68 | −0.60 | −0.76 | −0.90 | −0.97 | 0.15 |
| Fact2 | | 1 | −0.78 | 0.17 | −0.33 | −0.64 | −0.52 | −0.44 | −0.68 |
| Fact3 | | | 1 | 0.38 | 0.57 | 0.83 | 0.88 | 0.88 | 0.22 |
| Fact4 | | | | 1 | 0.50 | 0.37 | 0.59 | 0.70 | −0.72 |
| D1S1 | | | | | 1 | 0.90 | 0.79 | 0.62 | −0.01 |
| D2S1 | | | | | | 1 | 0.92 | 0.77 | 0.25 |
| D1S2 | | | | | | | 1 | 0.93 | 0.03 |
| D1S3 | | | | | | | | | −0.16 |
| Acrylamide | | | | | | | | | 1 |

FIG. 3C shows the trend of the scattering at 430 nm during the roasting process, subdivided into 13 steps for an overall duration of approximately 3 h. The progressive decrease in the scattering intensity corresponds to the absorption induced by the Maillard molecules; it is closely correlated with the color, measured with a colorimeter. FIG. 3A illustrates the multilinear regression model of the acrylamide content (x axis: predicted content, in μg/kg; y axis: measured content) obtained solely from the fluorescence data; FIG. 3B illustrates the regression model obtained by also using the elastic scattering. In both cases, the calibration was done on a basis of 68 samples. As in the case of the control of the cooking of the meat, a substantial improvement in the prediction is observed, with a mean square error which changes form 356 μg/kg to 276 μg/kg.

1. A method for characterizing at least one sample, comprising:
a) lighting of said or each sample to be analyzed by N≧1 light radiations (LE¹-LE³) at respective lighting wavelengths (λ_{E}¹-λ_{E}³);
b) acquiring, for each said light radiation, of at least one fluorescence light intensity and of at least one elastic scattering light intensity emitted by said or by each sample;
c) for said or each sample, the determination of a vector indicator from said fluorescence and elastic scattering light intensities;
d) the determination of at least one parameter characterizing each sample, or a method to which said sample has been subjected, from the corresponding vector indicator.

2. The method as claimed in claim 1, in which said fluorescence and elastic scattering light intensities are acquired in frontal mode.

3. The method as claimed in claim 1, in which said step a) comprises the lighting of said or each sample to be analyzed by a number between 1 and 6 of substantially monochromatic light radiations.

4. The method as claimed in claim 1, in which said step b) comprises, for said or each sample, acquiring of at least one fluorescence spectrum and said step c) comprises, also for said or each sample:
the computation of a scores vector by the application of a multivariable or multiway statistical model to said or to each fluorescence spectrum, said statistical model being defined by a lighting loadings vector and by a fluorescence loadings vector; and
the concatenation of said scores vector with at least one elastic scattering intensity value or a parameter characteristic of at least one elastic scattering spectrum.

5. The method as claimed in claim 4, in which said statistical model implemented in the step c) is chosen from a PARAFAC model and an NPLS model.

6. The method as claimed in claim 4, in which said step b) comprises, for said or each sample, acquiring of at least one spectrum comprising contributions due to the fluorescence and to the elastic scattering, and the subtraction of said contributions due to the elastic scattering of the excitation light radiation, said contributions due to the elastic scattering being computed by means of a generalized linear model.

7. The method as claimed in claim 4, also comprising a preliminary calibration phase comprising:
i) lighting of a plurality of calibration samples by said N≧1 light radiations at said respective lighting wavelengths;
ii) acquiring for each said calibration sample, of said fluorescence spectrum or spectra;
iii) the determination, by an iterative method, of said loadings vectors of the statistical model, and of a scores vector for each calibration sample.

8. The method as claimed in claim 1, in which said step d) of determination of at least one parameter characterizing each sample, or a method to which said sample has been subjected, is implemented by a method chosen from:
a multilinear regression from said vector indicator;
the computation of a distance between said vector indicator and a reference vector;
a supervised or unsupervised classification method; and
a “scoring” method.

9. The method as claimed in claim 8, also comprising a preliminary calibration phase comprising the determination of a function linking said vector indicator to the known values of said or each parameter for said calibration samples.

10. The method as claimed in claim 1, in which said or each sample is a product chosen from a food, a medicine, a biological medium or an environmental medium.

11. The method as claimed in claim 1, in which said or each said scalar or vector parameter is representative of a physical chemical structure of a matrix of said sample, or of a transformation of said physical chemical structure.

12. An apparatus for characterizing at least one sample comprising:
at least one light source for lighting said or each sample to be analyzed by N≧1 light radiations at respective lighting wavelengths (λ_{E}¹-λ_{E}³);
an acquisition device for acquiring at least one fluorescence light intensity and at least one elastic scattering light intensity emitted by said or by each sample for each said light radiation; and
a processor for processing data representing the acquired light intensities, programmed or configured to implement a method as claimed in claim 1.
